(19) United States
(12) Patent Application Publication
(10) Pub. No.: US 2003/0103356 A1
(43) Pub. Date: Jun. 5, 2003

(54) Underneath connector system

(76) Inventors: Nicholas D. Hutchins, Oakville (CA); J. Marc Hutchins, Oakville (CA)

Correspondence Address: Charles C Valauskas, Baniak Pine & Gannon, Suite 1200, 150 North Wacker Drive, Chicago, IL, 60606, US

(21) Appl. No.: 10/240,048

(22) PCT Filed: Mar. 26, 2001
(86) PCT No.: PCT/CA01/00383

(51) Int. Cl. F21S 2/00

(52) U.S. Cl. 362/382; 439/110

(57) ABSTRACT

An underneath connector system for a shaped lighting, guidance, communication, power generator, power supply, or power support, or other system that may be embedded in a mounting surface or anchored on a mounting surface. In embodiments, the underneath connector system comprises an elongated U-shaped housing with a pair of opposed arms and an intermediate base, the intermediate base having electrical conductors positioned or embedded therein. In another embodiment, the underneath connector system has at least one electrical conductor in an elongated support member and means for connecting the electrical conductor to an elongated system having a sliding means that permits relative movement between the electrical conductor and the elongated system. In a further embodiment, a plurality of modules are interposed between the at least one electrical conductor and the modules of the system, the plurality of interposed modules forming electrical connections. In a further embodiment power transfer to a shaped lighting, guidance, communication, power generator, power supply, or power support, or other system is achieved by the inclusion of a power induction system incorporated within the underneath connector system and the shaped lighting, guidance, communication, power generator, power supply, or power support, or other system. The preferred mounting surface is a road or airport runway.

### FIELD OF THE INVENTION

The present invention relates to a connector system, which will be referred to herein as an underneath connector system because it is intended to be located under, for example, a shaped lighting system, as that term is understood in this application. In particular, the underneath connector system is intended to be embedded in a mounting surface or located on a mounting surface. Examples of the mounting surface are a road, pavement, airport runway, ship deck, building side, rock tunnel face, or any other mounting surface.

### BACKGROUND OF THE INVENTION

Painted lines and other markings on pavements are important safety devices for guiding pedestrians, aircraft, road vehicles and other modes of transportation. At night, or because of heavy rainstorms, fog, snow, ice, dust, etc. there can be major problems in trying to view these markings, which often apparently completely disappear. This leaves pilots and motorists confused, with difficulty in maintaining their position in relation to obstacles or other vehicles.

Systems that are shaped—such as in an elongated, square, round, or other shape—and configured to provide lighting, guidance, communication, power generation, power supply, and power support—termed also for purposes of this application simply “shaped lighting systems”—are known. Shaped lighting systems are produced through molding, extrusion, or other means or methods. Certain of such systems are elongated in shape because they are linearly extruded and include encapsulated light emitting diodes (LEDs). The lighting systems are shaped to facilitate their use in various applications, such as installed in roads, airport runways and the like as a pavement inset, to form a lit guiding system for vehicles and people that reduces confusion and increases safety by making critical markings on the pavement visible in most weather conditions.

Shaped lighting systems typically use end connector systems. However, end connector systems lack the versatility required by, for example, the elongated LED lighting system disclosed in U.S. application Serial No. 60/157,484, filed Oct. 4, 1999 of Marc Hutchins and Nick Hutchins, and entitled “Elongated Light Emitting Diode Lighting System”.

A demand is, therefore, present for a connector system, particularly a system that may, for example, be located under a shaped lighting system, such as an LED lighting system, that is versatile. The present invention satisfies the demand.

### SUMMARY OF THE INVENTION

The present invention is a underneath connector system for a shaped lighting, guidance, communication, power generation, power supply, power support, or other system intended for use with a mounting surface, including roads and airports.

Accordingly, an aspect of the present invention provides an underneath connector system for an elongated electrical system, comprising:

at least one electrical conductor in an elongated support member;

means for connecting said electrical conductor to a shaped lighting, guidance, communication, power generation or other system, said means having a sliding means that permits relative movement between said electrical conductor and said shaped lighting, guidance, communication, power generation or other system.

Another aspect of the present invention provides an underneath connector system for shaped lighting, guidance, communication, power generation or other system, said system being in the form of modules, comprising:

at least one electrical conductor in an elongated support member;

a plurality of modules interposed between said at least one electrical conductor and said modules of the system, said plurality of interposed modules forming electrical connections between said electrical conductor and said modules of the system.

Further aspects of the invention are as follows:

An underneath connector system for a shaped lighting, guidance, communication, power generation or other system, said system being in the form of modules, comprising:

at least one electrical conductor in an elongated support member;

said modules being connected to the electrical conductor by pins or screws penetrating into the electrical conductor.

An underneath connector system for a shaped lighting, guidance, communication, power generation or other system, said system being in the form of modules, comprising:

at least one electrical conductor in an elongated support member;

said modules being connected to the electrical conductor by a magnetic, capacitive, or other inductive form of coupling, with or without the use of pins or screws penetrating into the electrical conductor. The necessary electronic, magnetic, and mechanical parts needed for such transmission of power from the underneath connector and said module may be positioned in the body of the underside connector and/or the said module.

An underneath connector system for a shaped lighting, guidance, communication, power generation, power supply, or power support, or other system to be embedded in a mounting surface, said system comprising an elongated U-shaped housing having a pair of opposed arms and an intermediate base, said intermediate base having electrical conductors embedded therein.

### BRIEF DESCRIPTION OF THE DRAWINGS

The present invention is illustrated by the embodiments shown in the drawings, in which:

FIG. 1 is a schematic representation of a cross section of one embodiment of an underneath connector system of the present invention;

FIG. 2 is a schematic representation of a perspective view of an underneath connector system of FIG. 1;

FIG. 2A is a schematic representation of an alternative embodiment of the underneath connector system of FIG. 2;

FIG. 3 is a schematic representation of a cross section of part of an underneath connector system with an elongated electrical lighting system;

FIG. 4 is a schematic representation of a cross section of an underneath connector system with an elongated electrical lighting system;

FIG. 5 is a schematic representation of a plan view of an embodiment of the lower module of FIG. 3;

FIG. 5A is a schematic representation of a plan view of an alternate embodiment of the lower module of FIG. 3;

FIG. 6 is a schematic representation of part of an alternate embodiment of an underneath connector system, in partially exploded view;

FIG. 7 is a schematic representation of the embodiment of FIG. 6 in a connected position, as a cross-section of FIG. 6 through line A-A;

FIG. 8 is a schematic representation of a further embodiment of part of an underneath connector system;

FIG. 9 is a schematic representation of another embodiment of part of an underneath connector; and;

FIG. 10 is a schematic representation of a still further embodiment of an underneath connector system.

### DETAILED DESCRIPTION OF THE INVENTION

The underneath connector system described herein is intended to be embedded in or located on a mounting surface. That mounting surface may be the ground, roads, pavement, airport runway, ship deck, building site floors, rock tunnel face, sides of vehicles, walls, ceilings, roof tops, sign boards, posts and a wide variety of other surfaces. For convenience, the invention is generally described herein with reference to the mounting surface being a ground surface but may be any surface.

The underneath connector system of the present invention is particularly intended to be utilized with a system shaped and configured for lighting, guidance, communication, power generation, power supply, power support, or other purpose, again termed more simply for purposes of this application “shaped lighting system”. In preferred embodiments, the present invention provides for immersion and weather proof connections, and power generation for shaped lighting systems. In embodiments, the present invention provides piercing of electrical conductors with non-corroding metal, metal plated or solid, gold, or other non-corroding electrodes and enabling the transfer of the power generation from the electrical conductors via the electrodes to the shaped system. In particular embodiments of the invention, the transfer of the power generation from the electrical conductors via the electrical connectors to the shaped system is achieved by induction using a magnetic, capacitive, frequency, or a combination of magnetic, capacitive, frequency, or other induction technique. Such magnetic induction techniques include magnetic coil and core elements alone or in conjunction with a frequency switching device. Alternatively, capacitive induction with frequency modulation may be used. Such embodiments are further advantageous in that elements—such as the non-corroding metal, metal plated or solid, gold or other non-corroding electrode elements—may be rendered thereby unnecessary. The system is intended to provide easy connection to power generation lines running in a U-channel support system and permits easy immersion and weather proof installation of the shaped lighting system and, if necessary, allows repairs to be carried out.

In particular embodiments of the invention, the underneath connector system would be embedded in the ground or other surface, on or adjacent to or instead of a U-channel support system, as disclosed in U.S. patent application No. 60/157,562 of Marc and Nicholas Hutchins, filed Oct. 4, 1999, and which is particularly intended to accommodate an elongated lighting, guidance, communication, power generation, power supply, or power support system as described in the aforementioned U.S. patent application No. 60/157,484 filed Oct. 4, 1999. The present invention will be particularly described herein with reference to an elongated electrical lighting system.

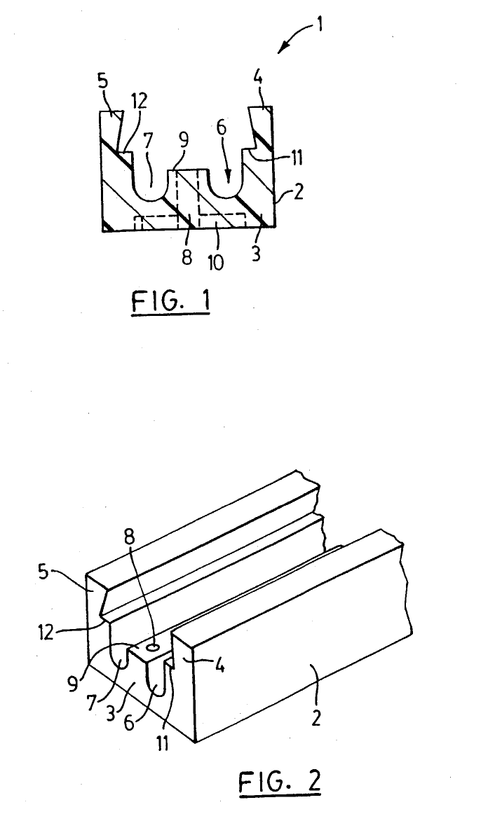

FIG. 1 shows an underneath connector system, generally indicated by 1. Underneath connector system 1 has housing 2, which has a base 3 intermediate between arms 4 and 5. Base 3 and arms 4 and 5 generally conform to a U-shape. Base 3 has two grooves 6 and 7, which extend downwardly into base 3. Grooves 6 and 7 are intended to contain an electrical conductor, as more clearly seen in FIG. 5.

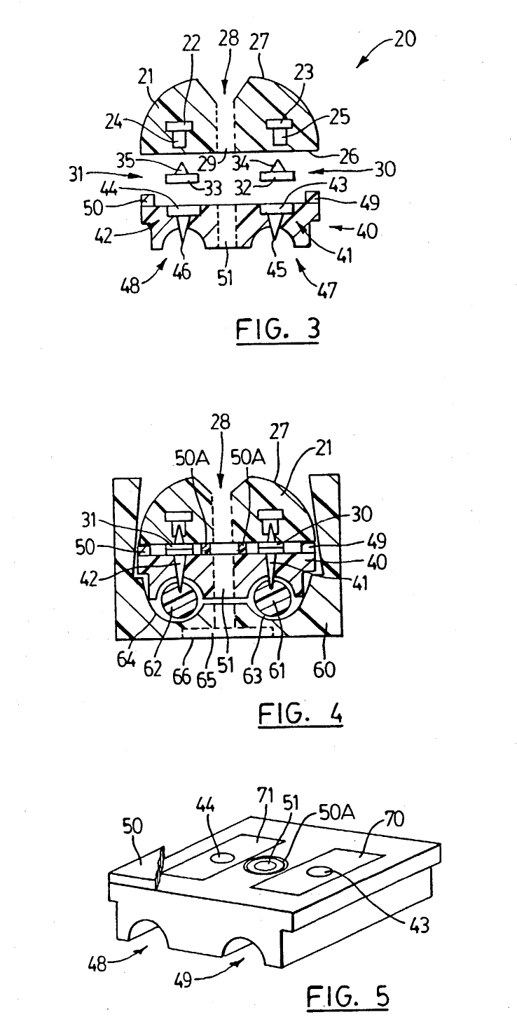

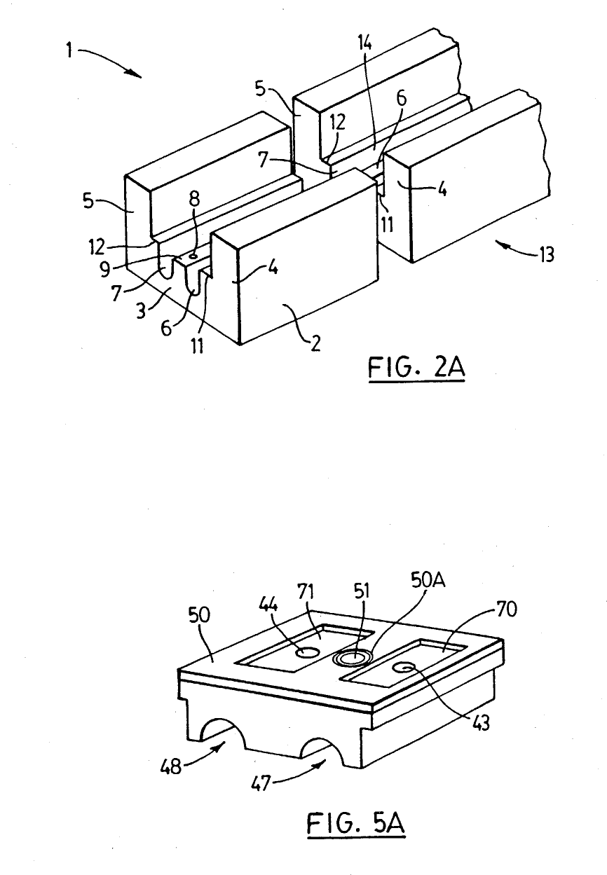

The external surface, or lower surface in use, of base 3 can be flat, but may also be textured or shaped—such as with grooves or protruding ridges to facilitate mounting of the system 1. An adhesive, such as glue or another fastening material, may be used instead or in conjunction with the texturing or shaping in order to locate and retain the system in place. In the embodiment shown in FIG. 1, base 3 is shown with channel 8 extending upwards (illustrated in phantom), through central support member 9. As more clearly seen in the FIG. 2, channel 8 is an orifice extending through base 3. Preferably, the embodiment of the system shown in FIGS. 1 and 2 includes a plurality of such channels located in central support member 9 in a spaced apart manner. Each channel 8 has recess 10 located in the lower surface of base 3, being symmetrically disposed about channel 8. Channel 8 and recess 10 are further discussed below.

Distal support member 11 is located between groove 6 and arm 4. Similarly, distal support member 12 is located between groove 7 and arm 5.

Arms 4 and 5 are shown in FIG. 1 as being inwardly arcuate, to assist in retention of an elongated lighting system within underneath connector 1. In another embodiment, arms 4 and 5 could be straight or shaped or aligned otherwise to facilitate the application. The internal surface of arms 4 and 5 may include a textured surface—such as a serrated surface or a smooth surface—to facilitate the application. When serrated, the serrations are preferably angled downwards towards the lower interior of underneath connector system 1 in order to further assist in retention of a shaped lighting guidance within underneath connector system 1.

The embodiment shown in cross section in FIG. 1 is shown in plan view in FIG. 2. For convenience, only one end of the embodiment of the underneath connector system is shown. Underneath connector system 1 as shown in FIG. 2 has housing 2. Housing 2 has base 3 and arms 4 and 5. Arms 4 and 5 extend for the length of underneath connector system 1. Base 3, as illustrated, has elongated grooves 6 and 7, which are in a side-by-side parallel relationship throughout the length of underneath connector system 1. Similarly in this embodiment, central support member 9 and distal support members 11 and 12 extend for the length of underneath connector system 1. Depending upon the embodiment, one or more channels may be located in central support member 9.

FIG. 2A shows a plan view of a variation of the embodiment shown in FIG. 2, in which the underneath connector system 1 is substantially shorter in length. In this embodiment, it is intended that underneath connector system 1 would be of a discrete length, rather than the extended length of FIG. 2. For instance, underneath connector system 1 could be as short as about 2 cm, i.e. of a length sufficient to provide the connections, or of a longer length, up to the extended lengths shown in FIG. 2. Underneath connector systems 1 would normally be interposed between sections of U-channel support system as disclosed in the aforementioned U.S. patent application No. 60/157,562. FIG. 2A shows an underneath connector system 1 with a U-channel support system, generally indicated by 13. U-channel support system 13 is of a complementary shape to underneath connector system 1 except that central support member 14 is of the height of distal support members 11 and 12. In underneath connector system 1, central support member 9 is lower than distal supports 11 and 12 so as to accept connector systems.

In use, U-channel support system 13 would be anchored to the ground or other substate. Underneath connector system 1 could also be anchored to the ground.

FIG. 3 shows a cross-section of an alternate embodiment of connector system 1. An LED module is generally shown as 20. In the embodiment shown, LED module 20 is of a shape that corresponds to the underneath connector shown in FIGS. 1 and 2. LED module 20 includes upper module 21 and lower module 40. Upper module 21 of LED module 20 includes two LEDs 22 and 23. Each of LEDs 22 and 23 includes a chamber 24 and 25, respectively, extending downwards beneath the LED module, but terminating above the lower surface 26 of upper module 21. The upper surface 27 of upper module 21 has a shaped recess 28—such as the illustrated V-shaped recess 28—that is centrally located and which connects with channel 29.

Pins 30 and 31 are located beneath upper module 21. Each of pins 30 and 31 has a head 32 and 33, respectively, attached to projection 34 and 35, respectively. Projections 34 and 35 are intended to insert into chambers 25 and 24 and to make electrical connection with LEDs 23 and 22, respectively.

Lower module 40 of LED module 20 has pins 41 and 42 in the upper surface thereof. Pins 41 and 42 have heads 43 and 44 connected to projections 45 and 46, respectively. The ends of projections 45 and 46 extend into connector recesses 47 and 48. Lower module 40 has channel 51 extending therethrough.

Seals 49 and 50 are located at peripheral locations between upper module 21 and lower module 40, to effect a water-tight seal between upper module 21 and lower module 40 when in use.

FIG. 4 shows upper module 21 and lower module 40, together forming LED module 20, located in an underneath connector 60. Pin heads 32 and 43 (see FIG. 3) are in contact, as are pin heads 33 and 44 (see FIG. 3). Pin projections 45 and 46 extend into electrical connectors 61 and 62, respectively, which are located in grooves 63 and 64 of underneath connector 60. Channels 28 and 51 are aligned with channel 65 in underneath connector 60. Although not shown in FIG. 4, it is intended that a bolt would be inserted into the shaped recess 28 such that it extends through channels 29, 51 and 65 and connect with a nut (not shown in FIG. 4) located in recess 66 (also shown in part as channel 8 and recess 10 in FIG. 1), in order to attach upper module 21 to lower module 40 and retain them in position.

Seals 49 and 50 are located at peripheral locations between upper module 21 and lower module 40. FIG. 4 additionally shows seal 50A around channel 51; seal 50A is not shown in FIG. 3 but is preferably to be used around the area at which channel 29 connects channel 51. Although not shown in FIG. 4, it is preferred to have seals around pins 41 and 42 in lower module 40, to seal the pins within the module and into electrical conductors 61 and 62 located in grooves 63 and 64.

FIG. 5 shows a plan view of lower module 40 such as shown in FIG. 3. Contact plates 70 and 71 are located above pin heads 43 and 44, and in electrical contact therewith. Similarly, contact plates 70 and 71 would be in electrical contact with pin heads 32 and 33 (not shown) when lower module 40 is aligned with upper module 21 as shown in FIGS. 3 and 4. Contact plates 70 and 71 are intended to maintain the electrical connection between the pinheads even if there is some misalignment of the pin heads in the installation and/or if relative movement of upper module 21 and lower module 40 should occur during use, e.g. as a result of an automobile passing over LED module 20. Such components of the system 1 that permit electrical connection to be maintained even if there is some relative movement—or “sliding”—of upper module 21 relative to lower module 40—such as during the movement of an auto over module 20, or even with expansion and contraction of the components of system 1 relative to each other—are appropriately termed “sliding means” for purposes of this application. It should be appreciated that “sliding means” includes not only mechanical means to provide physical contact between system components in order to facilitate the maintenance of electrical connection but also contact between any conductive gels and/or pads. Ring seal 50A may be positioned around channel 51 as shown in FIG. 5. A preferred embodiment is shown in FIG. 5A that includes seals 50 and 50A in order to form a continuous seal.

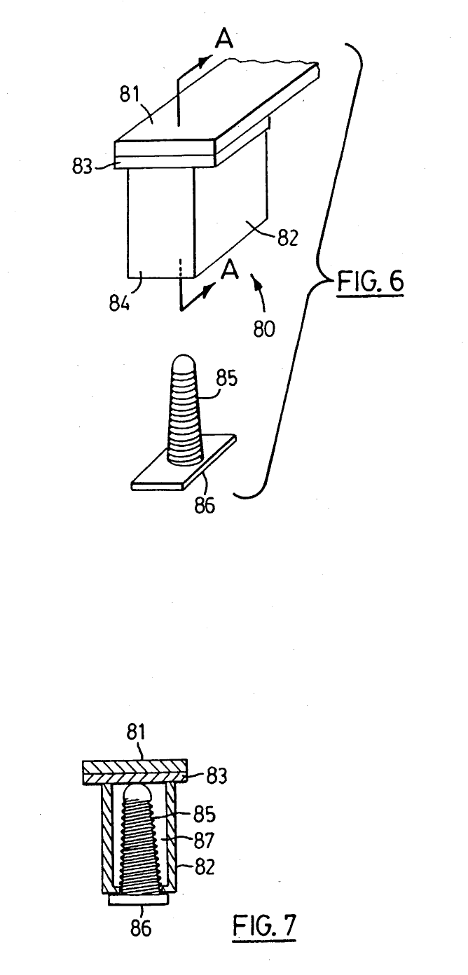

FIG. 6 shows an alternate underneath connector, generally indicated by 80 that includes alternative sliding means. Underneath connector 80 has a BUSS bar 81 with top plate 83 of connector 82 attached thereto under bar 81. Housing 84 of connector 82 extends downward from top plate 83. Housing 84 of connector 82 is hollow (see FIG. 7) and is intended to accommodate screw connector 85 located on plate 86 of an electrical connector. The electrical connector is the source of electricity.

FIG. 7 is a cross-section of the embodiment shown in FIG. 6 through line A-A and shows screw connector 85, on plate 86, located in housing 84. Screw connector 85 is shown as being in contact with top plate 83 and sides 82. Housing 84 is hollow but is shown as filled with a filler 87 to effect a seal. Alternatively, the walls of housing 84 could be of a thickness that screw connector 85 cuts into the walls to effect a seal as it is inserted into housing 84.

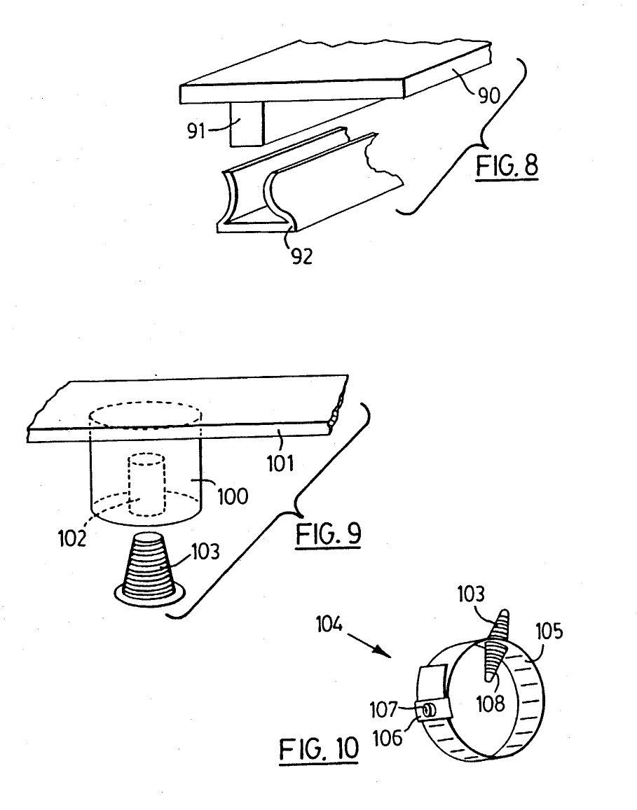

FIG. 8 shows a BUSS bar 90 from which knife plate 91 extends vertically from the lower surface thereof. BUSS bar 90 preferably forms part of an embodiment of an LED module. Knife plate 91 is intended to be inserted into double spring slot 92, which would be connected to a source of electricity. Knife plate 91 and double spring slot 92 are each of extended length to allow for relative movement of an LED module and the underneath connector and thereby provide an alternate embodiment of the system sliding means.

FIG. 9 shows a copper socket 100 attached to a BUSS bar 101 that provides also sliding means by which electrical connection may be maintained. Copper socket 100 has a hollow interior 102, for receiving a screw connector 103. Although not shown in FIG. 9, it is understood that screw connector 103 would be connected to an electrical conductor, e.g. using a pin or wire. An alternate embodiment is shown in FIG. 10, where screw connector 103 is attached to circular clip 104. Circular clip 104 which has a slotted band 105 that passes through bracket 106. Bracket 106 has screw 107 which is used to effect tightening of circular clip 104. In addition, circular clip 104 has electrical connector screw 108 on slotted band 105 on the interior surface of slotted band 105 at screw connector 103. In use, screw connector 103 would be connected to BUSS bar or other part of an LED module and an electrical conductor would be passed through the annulus of circular clip 104. On tightening of slotted band 105, electrical connector screw 108 would be forced into the electrical conductor to make electrical contact therewith.

It is understood that connection from underneath the shaped lighting system is important since any weight on the shaped lighting system, e.g. due to the passage of a vehicle over the system, will enhance the electrical connection and further seal the system against water penetration.

Filler pads, O-rings or filler mediums may be formed from a variety of water proof, water resistant glues, silicones, fluorosilicones and other materials and non-conductive materials, including plastics, EPDM (ethylenepropylene-diene) rubber or neoprene. The material is preferably compressible, to ensure good electrical contact and to preserve the immersion and weather proofing of the electrical connections.

The underneath connector system is intended to be embedded in the ground for installation. A groove is cut in the ground surface at a width and depth sufficient for the underneath connector system to be inserted in the ground. It is understood that arms 4 and 5 would typically be at a depth whereby, for example, the lighting strip would be level with or slightly below the ground, so that vehicles may readily pass over the shaped lighting system. In particular, snow-clearing vehicles at airports and on roadways need to be able to pass over the shaped lighting system without the blades from such vehicles either snagging on the underneath connector system or the shaped lighting system contained therein.

The underneath connector system is placed within the groove in the ground surface and held in place. For example, this may be done mechanically by drilling a hole through the complete system and inserting flush mounted expansion bolts, using hard setting epoxy, and/or by having adhesive underneath to assist with retention of the underneath connector system within the groove in the ground.

In alternate embodiments, the underneath connector system may be partially embedded within a groove in the ground or mounted above ground level, i.e. located on the surface of the ground. If the underneath connector system is partially embedded, it may be held in place by methods described above for the embedded system. When located completely above ground level, the underneath connector system may be anchored in position using spikes or other means that pass by or through the channel system, with a flush or recessed fitting with the channel system, to anchor the system to the ground.

A nut and bolt system can be used to anchor the shaped lighting system to electrical conductors, thus providing continuous compression for the electrical connectors and providing the necessary pressure on the filler pad, O-ring or filler mediums, so as to constantly maintain the immersion and weather proofing for the electrical connectors.

The underneath connector system may be formed from a variety of materials. For instance, the underneath connector system may be formed from rubber materials including recycled rubber, EPDM (ethylene-propylenediene rubbers), EPM (ethylenepropylene copolymer rubbers), neoprene, stainless steel, titanium, nickel coated steel, or any other non-corroding metal or plastic. These need to be of sufficient hardness and corrosive resistance to withstand normal use in the particular location of use.

The underneath connector system may be made by a variety of techniques, including but not limited to moulding and extrusion. For instance, if the underneath connector system has a degree of flexibility, the underneath connector system may be extruded in continuous lengths. In this manner, a long length of underneath connector system may be installed, and subsequently continuous or modular lengths of a shaped lighting system may be installed. However, in other embodiments, the underneath connector system is moulded or extruded in a modular length, and, in particular, in a modular length that corresponds to the modular length of a shaped lighting system.

The underneath electrical conductors would need to be provided with a connector system at one end, at each end, or the middle thereof. The channel system of the invention could be a conduit for other wires or for fibre optic cable. An additional groove may be required to accommodate such wires or cable.

The underneath connector system and channel system may also be provided with a base suitable for attachment to a particular mounting surface. For instance, if the surface was steel, e.g. the deck of a ship, a steel base could be provided or the material of the channel selected or treated to enhance adhesion to the mounting surface. One advantage of the channel system is that it allows for relatively easy access to the electrical conductors, so replacement of the underneath connector system, or modules of the shaped electrical lighting system can be readily carried out.

The underneath connector system and channel system, for a shaped lighting system, provides a protective shell for the electrical power generation distribution. This is especially useful in environments that impose high physical or other demands on the system, including use on roads. The system also provides quick and easy accessibility to the electrical power conductors, without digging for recovery, permitting maintenance or upgrades of the system that are less time consuming and less disruptive to users.

The surface of the underneath connector system may be adapted to the particular end-use. In particular, underneath connector channel may be sealed to the ground, e.g. road, whether concrete, asphalt or other surface. The underneath connector system and U-channel support system also assists in excluding water from lighting systems and their electrical connections.

In addition, the underneath connector system provides cushioning when loaded, e.g. when a vehicle passes over the underneath connector system and the shaped lighting system. The underneath connector system also allows the lighting to be removed if road repairs are required, while providing secure anchoring for the system to the electrical conductors.

An underneath connector system as described herein has a number of advantages. Electrical connections of the shaped lighting system located above the underneath connector system are protected and the weight of any vehicles passing over the lighting system further helps to retain contact between the lighting system and the underneath connector system. The system provides for relative or differential movement between the components of the shaped lighting system and the underneath connector system, and provides for multiple connections that provide redundancy in the connections to reduce the likelihood of electrical failure. The system may be mechanically locked together using bolts, adhesives, or glues, groutings, or other materials such as to effect the bonding of the system. Compressive seals are formed against a formed surface. Normally, there are no conventional wire connections between the underneath connector system and shaped lighting system, and thus there are no wires that could be sheared during use. However, it is understood that some systems may have wires for cross polarity connections. The system may be installed in the field, and further permits replacement of modules of a shaped lighting system without the underneath connector system being visible. Multiple BUSS wires may be used, e.g. for electricity, controls and antennas, with appropriate connections being made to the modules of the system to which the underneath connector system is attached. Long lengths of an underground connector system may be used, even though the shaped lighting or other system is modular in type.

Examples of mechanical connections to the underneath connector system includes screw-threaded pins, insert pins, wire wraps for induced signals, and clamping bands around the wire with contact pins or screws attached. The head of any mechanical pins may be a flat plate, double spring socket for knife edged connections, or other types. Tapered pins may also be used. The system may have compressive seals, O-rings, ring gaskets, nipples or other sealing mechanisms. The system may be further insulated with flexible silicone or other insulating material.

Electrical power generation connection from below the shaped lighting, system permits multiple power generation connections for redundancy and repair. It also increases the electrical connection. In use on the ground, the lighting, guidance, communication, power generation, power supply, or power support system would tend to be urged downwards into the electrical connection by the weight of traffic. Different sizes of filler or packing permit use of wire of different diameters. Thus, the underneath connector system of the invention is both rugged and versatile.

Embodiments of the system incorporating an inductance power generation system would reduce or eliminate the need for physical contact with the shaped lighting system and would provide superior waterproofing, as some, or all aspects of the induction system would be encapsulated, and incorporated within the underneath connector system. Components of the inductance system could be incorporated within shaped lighting system, so electrical connection could be accomplished. The inductance power generation system may include a system that transmits power by inductance from a connector to other system components. The power transmission system may include a magnetic coil, or capacitance and core inductor system, alone or in conjunction with a frequency switching device. The power transmission system may utilize a capacitance induction technique.

1. An underneath connector system for a shaped lighting system including electrical components by which the shaped lighting system is powered, comprising:
at least one electrical conductor in an elongated support member;
means for connecting said electrical conductor to the shaped lighting system, said means having a sliding means that permits relative movement between said electrical conductor and the electrical components of the shaped lighting system in order to facilitate maintenance of electrical connection.

2. The underneath connector system of claim 1 in which a module is interposed between said electrical conductor and said shaped lighting system, said module having said sliding connection, said module being electrically connected by metallic pins or screws to said electrical conductor.

3. The underneath connector system of claim 1 in which said underneath connector system and said shaped lighting system are adapted to be inserted in a groove in a mounting substrate.

4. The underneath connector system of claim 1 in which said elongated support member is a U-shaped housing, said U-shaped housing having a pair of opposed arms and an intermediate base, said housing having at least one longitudinal groove inserted in said intermediate base, said groove being adapted to accommodate said electrical conductor.

5. The underneath connector system of claim 1 in which said conductor is a coated electrical conductor.

6. The underneath connector system of claim 1 wherein said shaped lighting system is embedded in a mounting surface.

7. The underneath connector system of claim 4 in which said U-shaped housing has a pair or more of said longitudinal grooves spaced apart and in a side-by-side arrangement in said intermediate base, each of said grooves being adapted to accommodate said electrical conductor that includes a coated surface, said housing having support members disposed between and distal to each of said grooves, said support members being substantially coplanar, each of said grooves being of a depth to fully accommodate said electrical conductor.

8. The underneath connector system of claim 7 in which the grooves are of a depth such that said coated surface of said electrical conductor is coplanar with said support surfaces.

9. The underneath connector system of claim 7 in which the grooves are of a depth such that said coated surface of said electrical conductor is within said groove.

10. The underneath connector system of claim 7 in which the system is a shaped lighting system with LED lighting or other electrical components in an arrangement embedded in a transparent, semi-transparent, opaque, mixed transparent and opaque, or coloured plastic with electrical contacts disposed longitudinally within said plastic, said electrical contacts being in a spaced apart relationship corresponding to said grooves in the underneath connector system, said plastic being located in the support system.

11. The underneath connector system of claim 7 including electrical contacts disposed longitudinally in an intermittent arrangement.

12. The underneath connector system of claim 10 in which said plastic is separated from said coated surface by a continuous or intermittent filler pad, O-ring, or filler mediums.

13. An underneath connector system for a shaped lighting system, said system being in the form of modules, comprising:
at least one electrical conductor in an elongated support member;
a plurality of modules interposed between said at least one electrical conductor and said modules of the system, said plurality of interposed modules forming electrical connections between said electrical conductor and said modules of the system.

14. The underneath connector system of claim 13 in which the interposed modules are connected to said electrical conductor by screws or pins.

15. The underneath connector system of claim 14 in which said support member is an elongated U-shaped housing.

16. The underneath connector system of claim 14 in which said screws or pins are spaced at intervals along said electrical conductor.

17. An underneath connector system for a shaped lighting system, said system being in the form of modules, comprising:
at least one electrical conductor in a shaped support member;
said modules being connected to said electrical conductor by pins or screws penetrating into the electrical conductor.

18. The underneath connector system of claim 17 in which said modules are connected to said electrical conductor through an intermediate module, at least one of the said modules and said intermediate module having said pins or screws.

19. The underneath connector system of claim 17 in which said modules and said support member are held in contact by compression.

20. The underneath connector system of claim 19 in which said modules and said support member are held in contact by a nut and bolt system, said nut being located in and beneath said support member.

21. The underneath connector system of claim 19 in which the underneath connector system is adopted to be anchored.

22. An underneath connector system for a shaped lighting system to be embedded in a mounting surface, comprising:
an elongated U-shaped housing, said U-shaped housing having a pair of opposed arms and an intermediate base, said intermediate base having electrical conductors embedded therein.

23. An underneath connector system that provides electrical power generation connection for a shaped lighting system comprising:
components that transmit power by inductance from a connector to other system components.

24. The underneath connector system of claim 23 in which said power transmission components include a magnetic coil and core inductor system alone or in combination or in conjunction with a frequency switching device.

25. The underneath connector system of claim 23 in which said power transmission system utilizes a capacitance induction technique.
